(19) United States
(12) Patent Application Publication
(10) Pub. No.: US 2023/0266033 A1
(43) Pub. Date: Aug. 24, 2023

(54) OPERATING A FAN-BASED DEVICE TOGETHER WITH AN AIR PURIFIER TO ACHIEVE A COMBINED EFFECT

(71) Applicant: SENSIBO LTD., Ramat Gan (IL)

(72) Inventors: Ran ROTH, Ramat Gan (IL); Omer ENBAR, Ramat Gan (IL); Gilad GERSHTEIN, Ramat Gan (IL)

(21) Appl. No.: 18/142,924

(22) Filed: May 3, 2023

Related U.S. Application Data
(63) Continuation of application No. PCT/IL2021/051416, filed on Nov. 28, 2021.
(60) Provisional application No. 63/119,688, filed on Dec. 1, 2020.

(51) Int. Cl. F24F 11/65; G05B 19/042; F24F 8/00; F24F 11/77

(52) U.S. Cl. CPC F24F 11/65; G05B 19/042; F24F 8/00; F24F 11/77; G05B 2219/2614; F24F 2130/40

(57) ABSTRACT

A method, system and product, comprising: determining, in an environment where an air purifier and a fan-based device are deployed, an operation to be performed by the fan-based device, wherein the operation is configured to achieve a desired effect together with a purifying operation of the air purifier, wherein the air purifier and the fan-based device are physically separated, wherein the air purifier is being operated to purify an air within the environment, wherein said determining the operation comprises selecting a configuration for the fan-based device that is configured to cause the fan-based device to perform the operation; and instructing the fan-based device to implement the configuration, whereby causing the fan-based device to perform the operation; whereby the air purifier and the fan-based device achieve the desired effect together.

### CROSS-REFERENCE TO RELATED APPLICATION

This application is a continuation of International Patent Application No. PCT/IL2021/051416, filed Nov. 28, 2021, which claims the benefit of U.S. Provisional Application No. 63/119,688 filed Dec. 1, 2020, titled “Method and system for a smart sensing multi-device connected air quality and purification solution”, which is hereby incorporated by reference in its entirety without giving rise to disavowment.

### TECHNICAL FIELD

The present disclosure relates to air purifiers in general, and to operating a fan-based device together with a fan purifier in order to achieve a combined effect, in particular.

### BACKGROUND

An air purifier may be configured to purify air within a space. As air moves through a filter of the purifier, pollutants, gases, and particles such as dust, smoke, or the like, may be captured in the filter, and neutralized. The filtered air may be recirculated into the space.

In some cases, air purifiers may be configured to diagnose and report pollutants in real time, such as by using an air quality sensor embedded within the air purifier.

### BRIEF SUMMARY

One exemplary embodiment of the disclosed subject matter is a method operated in an environment where an air purifier and a fan-based device are deployed, wherein the air purifier and the fan-based device are physically separated, wherein the air purifier is being operated to purify an air within the environment, the method comprising: determining an operation to be performed by the fan-based device, wherein the operation is configured to achieve a desired effect together with a purifying operation of the air purifier, wherein said determining the operation comprises selecting a configuration for the fan-based device that is configured to cause the fan-based device to perform the operation; and instructing the fan-based device to implement the configuration, whereby causing the fan-based device to perform the operation; whereby the air purifier and the fan-based device achieve the desired effect together.

Optionally, determining the operation may be performed in response to a determination that a noise constraint within the environment is violated, wherein the desired effect is a decrease in a sound produced by fans of the air purifier and the fan-based device, wherein the configuration is configured to reduce a sound emitted by the fan-based device.

Optionally, determining the operation comprises detecting a presence of a living subject in the environment, and determining the noise constraint based on the presence of the living subject in the environment.

Optionally, the method comprises instructing the air purifier to reduce a fan speed, whereby reducing sound emitted by the air purifier.

Optionally, the noise constraint comprises a constraint on a noise level that can be produced at a defined distance from a living subject.

Optionally, the method comprises detecting a location of a living subject in the environment; and determining a target area based on the location of the living subject; wherein the desired result is focusing air circulation at the target area, whereby directing air flow of purified air to the living subject, wherein the purified air is purified by the air purifier.

Optionally, the method comprises determining an air quality level at the target area, wherein the operation is subject to the air quality level being below a threshold, whereby improving air quality at the target area.

Optionally, the configuration for the fan-based device is a mode of air re-circulation of the fan-based device, whereby affecting the operation of the air purifier by the fan-based device.

Optionally, the mode of air re-circulation of the fan-based device is determined based on an air pollution level at the environment and an air pollution level at a location external to the environment.

Optionally, the desired effect is an increase in a coverage of an air circulation in the environment, wherein the operation is an increase of a fan-speed of the fan-based device; a change in a direction of an air output from the fan-based device, or the like.

Optionally, the method comprises determining that a current coverage of air circulation in the environment is insufficient, wherein said determining that the current coverage is insufficient comprises: determining a difference between an expected speed of air purification by the air purifier, and a measured speed of air purification, wherein the expected speed of air purification is determined based on a volume of air in the environment, wherein the measured speed of air purification is measured using a sensor.

Optionally, in response to a determination that the measured speed of air purification is higher than the expected speed of air purification, determining that the current coverage is insufficient.

Optionally, the air purifier comprises the sensor, wherein the measured speed of air purification is measured using at least two sensor readings by the sensor.

Optionally, the measured speed of air purification is measured without using any air quality sensor external to the air purifier.

Optionally, the increase in the coverage of the air circulation is achieved by instructing to open a window in response to determining that a measured air pollution of outside air is lower than a measured air pollution of inside air.

Another exemplary embodiment of the disclosed subject matter is an apparatus comprising a processor and coupled memory, said processor being adapted to perform, in an environment where an air purifier and a fan-based device are deployed, the steps of: determining an operation to be performed by the fan-based device, wherein the air purifier and the fan-based device are physically separated, wherein the air purifier is being operated to purify an air within the environment, wherein the operation is configured to achieve a desired effect together with a purifying operation of the air purifier, wherein said determining the operation comprises selecting a configuration for the fan-based device that is configured to cause the fan-based device to perform the operation; and instructing the fan-based device to implement the configuration, whereby causing the fan-based device to perform the operation; whereby the air purifier and the fan-based device achieve the desired effect together.

Yet another exemplary embodiment of the disclosed subject matter is a computer program product comprising a non-transitory computer readable medium retaining program instructions, which program instructions when read by a processor, cause the processor to perform a method in an environment where an air purifier and a fan-based device are deployed, wherein the air purifier and the fan-based device are physically separated, wherein the air purifier is being operated to purify an air within the environment, the method comprising: determining an operation to be performed by the fan-based device, wherein the operation is configured to achieve a desired effect together with a purifying operation of the air purifier, wherein said determining the operation comprises selecting a configuration for the fan-based device that is configured to cause the fan-based device to perform the operation; and instructing the fan-based device to implement the configuration, whereby causing the fan-based device to perform the operation; whereby the air purifier and the fan-based device achieve the desired effect together.

### BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 shows a schematic illustration of an environment, in accordance with some exemplary embodiments of the disclosed subject matter;

FIG. 2 is a flowchart diagram of a method, in accordance with some exemplary embodiments of the disclosed subject matter; and

FIG. 3 is a block diagram of an apparatus, in accordance with some exemplary embodiments of the disclosed subject matter.

### DETAILED DESCRIPTION

One technical problem dealt with by the disclosed subject matter is enhancing a performance of an air purifier. In some cases, in contrast to some laboratory conditions, environmental and real-world conditions may adversely affect a performance of air purifiers.

Another technical problem dealt with by the disclosed subject matter is measuring an actual effectiveness of an air purifier, in a deployed environment. In some cases, an air purifier may report pollution levels, pollution rates, or the like, in real time, such as via a display, via communication messages with a user device of a user, or the like. In some cases, the pollution levels may be measured by one or more embedded or associated sensors of the air purifier, such as by an embedded air quality sensor. In some cases, the reported measurements may not always be precise. For example, in case the air circulation is low, the air purifier may only filter air in a near proximity thereto, such as within a range of one meter from the air purifier, without having an effect on other areas of the environment that may be more important to the user. In such a case, the air purifier may report a high air quality with low pollution levels, although the actual pollution level in the surrounding environment may be, in average, much higher. It may be desired to measure an actual effectiveness of air purifiers, such as within an entire designated environment.

Yet another technical problem dealt with by the disclosed subject matter is balancing between an effectiveness of an air purifier with respect to the resulting air quality, and personalized user preferences.

Yet another technical problem dealt with by the disclosed subject matter is balancing between an effectiveness of an air purifier with respect to the resulting air quality, and between a nuisance caused to users by a noise level of the purifier. In some cases, air purifiers may include multiple fan modes or configurations that indicate a respective speed of a fan within the air purifier. In some cases, as the fan mode in higher, indicating a faster speed of the fan, and a better air circulation, the noise created by the air purifier may be louder, stronger, more irritating for users, or the like. In some cases, the noise produced by an air purifier may be combined with noises from fans, air conditioners, or the like. A naïve solution to the noise obstacle may include setting the mode of the air purifier to a low setting that creates less of a nuisance. However, the naïve solution may have one or more drawbacks, since keeping the fan in a low speed may adversely affect the air circulation, resulting with poor air quality. It may be desired to maximize the air quality, while complying with one or more noise nuisance constraints.

Yet another technical problem dealt with by the disclosed subject matter is enhancing an effect of the air purifier's fan, which may not always be sufficiently effective, and may cause strong noise nuisance.

One technical solution provided by the disclosed subject matter includes configuring a controllable group of one or more fan-based devices in an environment to optimize an air quality of the environment or one or more portions thereof, to comply with one or more constraints, a combination thereof, or the like. In some exemplary embodiments, the controllable group may include one or more air purifiers, fan-based devices such as Heating, Ventilation, or Air Conditioning (HVAC) units, or the like. In some cases, a fan-based device may refer to a device that comprise at least one fan. In some exemplary embodiments, one or more air purifiers deployed in the environment may be operated to purify an air within the environment. In some exemplary embodiments, one or more additional devices may be deployed in the environment, such as one or more fan-based devices, sensors, communication devices, window or door controlling devices, or the like.

In some exemplary embodiments, the controllable group may be deployed and operated in the environment, externally to the environment, or the like. In some exemplary embodiments, the environment may include a space such as a room, separate environments, adjacent environments, or the like. For example, the environment may include an area of one or more rooms in which one or more purifiers are located, a house or apartment in which a purifier is located, a public environment in which a purifier is located, or the like.

In some exemplary embodiments, an air purifier may be physically separated from fan-based devices, may have separate structures therefrom, may have separate communication modules therefrom, or the like. In some exemplary embodiments, an air purifier, also referred to as a ‘purifier’, may include an air quality and purification system, or any other system that is configured to purify air, clean air, reduce a pollution level, filter out pollutants, or the like. In some exemplary embodiments, the air purifier may comprise a fan that is configured to draw air to an embedded filter of the purifier, which may capture pollutants and particles of the air, and release the remaining air back to the room. In some exemplary embodiments, air purifiers may comprise one or more sensors, such as an air quality sensor configured to measure an air quality.

In some exemplary embodiments, the controllable group may comprise fan-based devices, such as one or more fans, air conditioners, air purifiers, or the like. For example, a first purifier may be deployed in an environment, and one or more additional purifiers may be deployed in the vicinity of the purifier, in one or more adjacent environments belonging to a same user, or the like. In some exemplary embodiments, the fan-based devices may comprise one or more Heating, Ventilation, or Air Conditioning (HVAC) units such as air conditioning systems, fans, or the like. In some exemplary embodiments, the HVAC units may be deployed in the vicinity of the purifier, in one or more adjacent environments belonging to a same user, or the like. In some exemplary embodiments, the activation and configurations of the fan-based device may affect the purification operation of the air purifier.

In some exemplary embodiments, the controllable group may comprise openings devices associated with one or more openings of a room. In some exemplary embodiments, the opening devices may include a window controller, which may be configured to control an opening or closing of a window, a window shutter, or the like, within the environment. In some exemplary embodiments, the opening devices may include a door controller, which may be configured to control an opening or closing of a door within the environment. In some exemplary embodiments, the opening devices may comprise detection sensors that may be configured to detect a window state, indicating whether or not the window is open, a door state, a shutter state, or the like.

In some exemplary embodiments, the controllable group may comprise one or more sensors deployed in various positions in the room. In some exemplary embodiments, the sensors may comprise independent sensors, that can be deployed and installed independently, and/or embedded sensors that are embedded within a device. In some cases, sensors may be embedded within a remote control of an air conditioner, within a fan-based device, or the like. For example, an air quality sensor may be embedded within a purifier.

In some exemplary embodiments, the controllable group may comprise one or more sensors for monitoring the air quality level, air pollution level, or the like (referred to as ‘air sensors’). Such sensors may be deployed in various positions, in various heights, or the like. In some cases, based on a room profile, one or more locations for deploying air sensors may be determined to provide a wide range of positions and heights of the sensors, e.g., using an optimizer. In some exemplary embodiments, the air sensors may include gas sensors, such as a Total Volatile Organic Compounds (TVOC) sensor configured to detect or measure organic compounds in the air. In some exemplary embodiments, the air sensors may include pollution sensors, such as optical particle counters, dust counters, or the like, which may be configured to measure a pollution level of the air. In some exemplary embodiments, the air sensors may include air quality sensors, which may be configured to measure a quality level of the air, compare an air quality level to a metric, or the like. In some exemplary embodiments, the air sensors may include any other sensors for monitoring a composition of the air, a level of pollution in the air, a level of air circulation, or the like, such as a vibrations sensor that can determine a fan speed based on measured air movements.

In some exemplary embodiments, a profile, map, or characterization of the environment (e.g., a room profile) may be determined, obtained, or the like, such as based on user indications of properties of the environment, based on measurements of the environment, based on locations of one or more deployed sensors within the environment, or the like. In some exemplary embodiments, the environment profile may indicate a volume of the environment, relative locations of windows and doors within the environment, relative locations of sensors and/or fan-based devices within the environment, a diameter of the environment, measures thereof, or the like.

In some exemplary embodiments, the controllable group may comprise one or more sensors for monitoring environmental conditions, parameters, or the like (referred to as ‘environment sensors’), of an outside environment that is external to the environment of the purifier. In some exemplary embodiments, the environment sensors may include weather sensors, which may be configured to measure real time weather parameters such as an atmospheric pressure, an outside temperature, precipitations, or the like. For example, weather sensors may include barometric sensors and may be deployed in the vicinity of the purifier, such as on an external wall of a house or room in which the purifier is located. As another example, weather sensors may obtain signals or data communications from third party weather devices that are deployed in a city, zone, or country in which the purifier is located, such as via a remote server. In some exemplary embodiments, the environment sensors may include a local wind speed sensor, which may be configured to measure a local speed of the wind in the vicinity of the purifier, such as near a window of a room in which the purifier is positioned, or, alternatively, obtain wind measurements from third party devices. In some exemplary embodiments, the environment sensors may include any other sensor for measuring or obtaining environmental metrics, parameters, or the like, in an outside environment of the purifier, such as a temperature sensor, a humidity sensor, or the like.

In some exemplary embodiments, the controllable group may comprise one or more sensors for detecting user locations (referred to as ‘user sensors’). In some cases, the user sensors may comprise, inter alia, a presence sensor, a proximity sensor, or the like, which may be used to detect whether a living subject such as a human or animal is located in a vicinity of the purifier. A presence sensor may comprise passive infrared detectors, ultrasonic detectors, a Bluetooth Low Energy (BLE) proximity sensor, or the like. For example, a presence sensor may utilize infrared sensors to detect the infrared radiation emanating from living subjects in the environment. In some exemplary embodiments, the user sensors may comprise, inter alia, geolocation sensors, which may be configured to indicate a geolocation of a user. For example, geolocation sensors such as a Global Positioning System (GPS) may be embedded within a computing device of a human user, and may be configured to provide geolocation data, such as geographical coordinated indicating a current location of the user. In some exemplary embodiments, the user sensors may comprise, inter alia, indoor positioning systems such as BLUETOOTH™ Low Energy (BLE) beacons that enable to estimate an indoor location of a user device communicating therewith without utilizing satellite-based communications. In some exemplary embodiments, the user sensors may comprise, inter alia, a microphone sensor that may be used to detect sounds that are indicative of a person being located in the environment. In some exemplary embodiments, the user sensors may comprise any other sensor used to locate or detect a presence of living subjects with respect to one or more designated environments, a vicinity of the purifier, or the like.

In some exemplary embodiments, the controllable group may be controllable, such as from a remote server, a computing device, a smartphone, or the like, which may be configured to instruct devices or sensors of the controllable group by sending instruction messages or signals thereto, utilizing a remote controller, mimicking messages of a remote controller, or the like. In some exemplary embodiments, the controllable group may be controllable via a communication medium such as Radio Frequency (RF) communications, WI-FI™ or Internet communications, BLUETOOTH™ communications, ultrasonic communications, Infrared (IR) communications, or the like. For example, in case a HVAC unit of the controllable group comprises an infra-red receiver, the HVAC unit may be instructed by sending infra-red instructions thereto. In some cases, different devices of the controllable group may be controlled using different types of messages and communication mediums, according to corresponding receivers and communication protocols of the devices.

In some exemplary embodiments, the controllable group, or portions thereof, may be utilized to achieve a desired effect, such as to increase an air circulation in the environment, to reduce a noise level, a combination thereof, or the like. In some exemplary embodiments, a group plan (also referred to as an ‘air purification group plan”) for at least one air purifier and at least one other fan-based device may be determined. In some exemplary embodiments, the other fan-based device may comprise an HVAC device, an air purifier that is not actively purifying the environment, or the like. In some exemplary embodiments, the group plan may include determining at least one operation to be performed at least by the one other fan-based device of the controllable group. In some exemplary embodiments, the group plan may include retaining the current operation state of the air purifier, or determining one or more operations for the purifier as well. In some exemplary embodiments, the operation of the other fan-based device may be configured, together with the air purifier, to achieve a combined desired effect that combines the effects of the active air purifier and the other fan-based device. In some exemplary embodiments, a group plan for the controllable group may be determined to comply with one or more objectives, constraints, sensor readings, or the like.

In some exemplary embodiments, the group plan may be determined to comprise fan configurations of one or more fan-based devices, openings configurations of opening devices, or the like. In some exemplary embodiments, determining an operation for a fan-based device may comprise selecting a configuration for the fan-based device implementing the operation. The implementation of the operation of each fan-based device in the group plan, together with the air purifier, may be estimated to provide the desired effect. In some exemplary embodiments, the operation to be performed may be determined periodically, upon determining an event, or the like, such as based on one or more communications, sensor measurements, heuristics, user instructions, or the like. In some exemplary embodiments, the operation may be determined based the sensors of the controllable group, which may be utilized, analyzed, processed, or the like, in order to detect one or more events that require adjustments of configurations of the controllable group, states that violate constraints, or the like. In some exemplary embodiments, sensor readings may be obtained and processed periodically, continuously, or the like. In some exemplary embodiments, the operation to be performed may be determined based on the detected events, such as in order to fix problems detected by the events. In some exemplary embodiments, the operation to be performed may be determined based on an indication, a predefined setting, or the like, such as upon determining that at least one air purifier is activated, e.g., without detecting an event.

In some exemplary embodiments, determining an operation of a fan-based device may comprise selecting a configuration of the device. In some exemplary embodiments, in response to selecting a configuration, the fan-based device may be instructed to implement the determined configuration, to thereby cause the fan-based device to perform the operation as part of the group plan. In some exemplary embodiments, the air purifier and the fan-based device may achieve the desired effect together, by the fan-based device performing the operation and the air purifier purifying the air simultaneously, subsequently, or the like.

In some exemplary embodiments, the desired effect may be an increase in coverage of air circulation in the environment. In some exemplary embodiments, the operation may comprise increasing a fan-speed of the fan-based device, changing a direction of air output from the fan-based device, or the like. In some exemplary embodiments, in case the desired effect is an increase in coverage of air circulation, the operation may be determined in response to measuring that a coverage of the air circulation (indicating a percentage of the environment air that is efficiently circulated) is lesser than a threshold, in response to detecting an inefficient circulation event, in response to activating the air purifier, periodically, or the like.

In some exemplary embodiments, the controllable group may be utilized to measure an air circulation coverage or effect within the environment, and compare it to one or more thresholds. In some exemplary embodiments, that current coverage of air circulation in the environment may be determined to be insufficient, such as by comparing measurements of different air sensors deployed in different areas of the room, and identifying an inconsistency between the measurements. In some exemplary embodiments, a circulation coverage may be measured by a combination of one or more air sensors that may measure the air quality in different heights of the room, different positions of the room, or the like. For example, air sensors at different parts of a room may measure different air pollution levels (e.g., different particle counts) due to a low air circulation. In case of effective air circulation, air sensors at different parts of a room may measure a same or similar (lesser than a threshold) air pollution level.

In some exemplary embodiments, a current coverage of air circulation in the environment may be measured, such as based on a speed of air purification, which may be measured without requiring multiple air sensors, such as based on a single air sensor. In some exemplary embodiments, a speed of air purification may indicate a speed of improvement between different measurements of a same air sensor. In some exemplary embodiments, a current coverage of air circulation in the environment may be measured by determining a difference between an expected speed of air purification by the air purifier, and a measured speed of air purification that is measured using a sensor. For example, the sensor may include an air sensor of the air purifier, or any other air sensor. In some exemplary embodiments, the measured speed of air purification may be measured using at least two sensor readings by the sensor, e.g., at a start of a time period, such as upon activation of the purifier, and after the time period elapsed, enabling to compare the measurements and determine a speed of air purification corresponding to the duration. In some cases, in case the sensor is embedded within the air purifier, the measured speed of air purification may be measured without using any air quality sensor external to the air purifier. In some exemplary embodiments, the expected speed of air purification may be determined based on a volume of air in the environment, e.g., which may be defined or derived from a room profile of the room, based on properties of the air purifier, or the like. For example, a profile of a room may be determined or obtained, and an expected speed of increasing an air quality may be determined based on the room profile, such that larger rooms with larger air volumes require more time to be purified compared to smaller rooms. In some exemplary embodiments, in response to a determination that the measured speed of air purification is higher than the expected speed of air purification, or that the difference is greater than a threshold, which may indicate that the air sensor is sampling and filtering air in its immediate vicinity, without effecting the remaining air of the room, the current circulation coverage may be determined to be insufficient.

In some exemplary embodiments, in response to determining that the actual air circulation level is low, ineffective, lesser than a circulation threshold, or the like, a configuration for implementing the operation and increasing the air circulation may be determined, selected, or the like. In some exemplary embodiments, at least one fan-based device may be instructed to implement the configuration. In some exemplary embodiments, increasing the air circulation may include causing more air, from more areas of the environment, to pass through filters of air purifiers, thereby increasing an effective air quality in the environment, and preventing cases of air purifiers that clean only their immediate vicinity. In some exemplary embodiments, the air circulation may be affected by a fan mode of the air purifier, in addition to a fan mode of other fan-based devices such as HVAC units, room openings such as an open window through which wind can flow, or the like. In some exemplary embodiments, the controllable group may be utilized to increase the air circulation by adjusting one or more fan configurations of fan-based devices, such as a speed of the fan, a direction thereof, or the like. In some exemplary embodiments, the controllable group may be utilized to increase the air circulation by controlling openings to the room, such as by instructing to open a window and enable wind to enter the room (e.g., in response to an environment sensor measuring a wind level). For example, the desired effect of increasing the air circulation may be achieved by instructing a user or a window opener to open a window, e.g., in response to determining that a measured air pollution of outside air is lower than a measured air pollution of inside air. In some exemplary embodiments, a group plan for the controllable group may be determined to include settings, configurations, or the like, of fan-based devices and/or opening devices that are expected to increase the air circulation of air in the environment. In some exemplary embodiments, the group plan may include, for example, turning on fan-based devices, increasing a fan configuration of fan-based devices, directing the flaps to one or more directions that have low air circulation, or the like.

In some exemplary embodiments, a desired effect of a group plan may comprise complying with constraints, e.g., user constraints, noise constraints, or the like. In some exemplary embodiments, an operation of a fan-based device may be determined to comprise adjusting configurations of one or more fan-based devices so that the constraints will be complied with. For example, in case of noise constraints, the desired effect may include a decrease in a combined sound produced by fans of the air purifier and the fan-based device. In some exemplary embodiments, the noise constraint may comprise a constraint on a noise level that can be produced with respect to a living subject, at a defined distance therefrom, or the like. In some exemplary embodiments, determining the operation may comprise detecting a presence of a living subject in the environment (using one or more user sensors), and determining the noise constraint based on the presence of the living subject in the environment. In some exemplary embodiments, the operation may be determined in response to a determination that a noise constraint within the environment is violated.

In some exemplary embodiments, a configuration of a fan-based device may be configured to implement the operation, such as by reducing a fan speed of the fan-based device, and thereby reducing a sound emitted thereby. In some cases, the air purifier, or any other fan-based device, may be instructed to reduce its fan speed, whereby reducing sound emitted by the air purifier. In some exemplary embodiments, a tradeoff may exist between noise levels and air circulation. In some exemplary embodiments, the group plan may be configured to ensure that the devices comply with noise constraints, while optimizing on other parameters such as an air circulation. For example, the operation of a fan-based device may be configured to produce the maximal air circulation, while complying with constraints such as noise constraints. In some exemplary embodiments, the group plan may be determined based on a map of fan configurations, which may map every fan configuration of every fan-based device to associated effects to the air circulation, to a direction thereof, to a noise level thereof, an effected area thereof, or the like.

In some exemplary embodiments, a desired effect of a group plan may comprise increasing an air quality level of air near a living subject. In some exemplary embodiments, an operation of a fan-based device may comprise, as part of the group plan, focusing air circulation at a target area associated with a living subject, whereby directing air flow of purified air to the living subject. In some exemplary embodiments, a location of a living subject in the environment may be detected, and a target area may be determined based on the location of the living subject, e.g., to include a defined range around the subject, a defined distance from the subject, or the like. In some exemplary embodiments, an air quality level may be determined at the target area. In some exemplary embodiments, subject to the air quality level in the target area being below a threshold, the operation may be configured to direct purified air that is purified by the air purifier to the target area, whereby improving air quality at the target area. Alternatively, the group plan may be configured to improve the air quality level in the target area based on any other determination, such as upon detection of a location of a living subject.

In some exemplary embodiments, a desired effect of a group plan may comprise selecting an optimal air source of an air circulation. In some exemplary embodiments, an operation of a fan-based device may comprise selecting an air re-circulation mode or a fresh air mode, based on one or more calculations, sensor readings, or the like. In some exemplary embodiments, a configuration for the fan-based device may comprise a mode selection of the fan-based device, affecting the purification and/or fan operation of the air purifier, as different air is provided to the air purifier in each mode. In some exemplary embodiments, the air source mode of the fan-based device may be determined based an air pollution level at the environment, an air pollution level at a location external to the environment, or the like. For example, in case the air pollution level within the environment is higher than the air pollution level externally to the environment, the mode of the fan-based device may be selected to include a fresh air mode, a window may be instructed to be opened, or the like. As another example, in case the air pollution level within the environment is lower than the air pollution level externally to the environment, the air re-circulation mode of the fan-based device may be instructed to be turned on, remained turned on, or the like, a window may be instructed to be closed, or the like. In some exemplary embodiments, an air source may be selected based on an event indicating that an air source should be selected, periodically, or the like. For example, events may include detecting that a window opened, detecting that a difference between indoor and outside air overpasses a threshold, or the like.

One technical effect provided by the disclosed subject matter is providing an increased quality of air within a space, in a pleasant manner and without causing noise disturbances to users in the vicinity. By configuring the controllable group of devices and sensors to operate optimally according to detected states and user constraints, the user is provided with a low disturbance system that provides an increased level of air purification.

Another technical effect provided by the disclosed subject matter is enabling to measure the actual effectiveness of an air purifier. By using multiple air sensors, a room profile, or the like, a coverage of the air circulation may be determined. This may enable to prevent scenarios in which the air purifier only filters air in a near proximity thereto, and reports inaccurate levels of air quality that are not accurate for the entire space.

Yet another technical effect provided by the disclosed subject matter is enabling to adjust settings of fan-based devices based on outside conditions.

Yet another technical effect provided by the disclosed subject matter is enabling to adjust settings of fan-based devices to focus an air purifying process on priority areas, such as a location of the user.

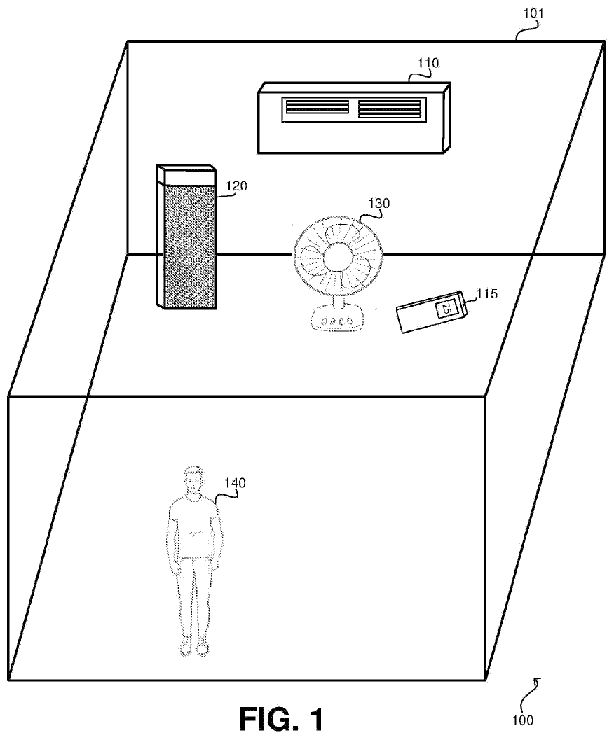

Referring now to FIG. 1, showing a schematic illustration of an environment, in accordance with some exemplary embodiments of the disclosed subject matter.

In some exemplary embodiments, Environment 100 may comprise an Air Purifier 120 within an environment such as a Room 101. In some exemplary embodiments, Air Purifier 120 may include one or more anti-viral filters, dust filters, smoke filters, organic filters, or the like. For example, the purifier may include an adsorbent, such as activated carbon, which may enable to purify capture gases like volatile organic compounds or radon. In other cases (not illustrated), Environment 100 may comprise any other number of air purifiers in Room 101, adjacent rooms, or the like.

In some exemplary embodiments, Environment 100 may comprise one or more other fan-based devices such as HVAC Unit 110 and HVAC Unit 130. In other cases (not illustrated), Environment 100 may comprise any other number of HVAC units of any type. HVAC Unit 110 may comprise an air conditioner, while HVAC Unit 130 may comprise a fan device. HVAC Unit 110 and HVAC Unit 130 may each comprise an internal fan that enables to circulate air within a room.

In some exemplary embodiments, HVAC Unit 110 may be installed anywhere in Room 101. HVAC Unit 110 may be connected to a compressor unit (not shown) or another operative unit which is typically installed externally to room 101. HVAC Unit 110 may comprise one or more modes, such as a cooling or heating mode utilizing the compressor unit, a fan mode utilizing an internal fan, a combined mode utilizing a combination of the compressor unit and the internal fan, or the like. The fan mode may comprise one or more fan speeds, one or more fan directions, or the like. HVAC Unit 110 may comprise a communication receiver, such as an Infrared (IR) receiver, Radio Frequency (RF) receiver, an ultrasonic receiver, or the like. In some exemplary embodiments, HVAC Unit 110 may comprise one or more sensors such as a temperature sensor, a humidity sensor, or the like. Remote Control 115 may have controls thereon to enable a user to manually submit commands to the HVAC Unit 110, such as start/stop, set the target temperature, set a timer, or the like, via one or more signals. Remote Control 115 may submit the commands using an IR transmitter, an RF transmitter, or the like. HVAC Unit 110 may determine, for example, by a controller thereof, whether and how to operate the unit, for example start/stop the compressor, set fan speed to high/low, set flaps direction, or the like, in response to control signals from Remote Control 115. Remote Control 115 may or may not comprise one or more sensors, such as a temperature sensor, a humidity sensor, or the like.

In some exemplary embodiments, HVAC Unit 130 may comprise a fan that circulates air within a room, and may be installed anywhere in Room 101. HVAC Unit 130 may comprise one or more fan speed modes, indicating different fan speeds, such as a low speed, medium speed, and high speed. HVAC Unit 130 may comprise one or more fan direction modes, indicating different fan directions, such as continuous change of direction over a defined angle, a static direction, or the like.

In some exemplary embodiments, one or more devices within Room 101, such as Air Purifier 120, HVAC Unit 110, Remote Control 115, HVAC Unit 130, sensors that are deployed in Room 101 or externally thereof (not depicted), windows (not depicted), shutters (not depicted), or the like, may include controllable devices that may be controllable from one or more computing devices via one or more communication mediums. The controllable devices may be controlled from a user device, a server, a remote source, or the like, via a communication medium such as WI-FI™ communication, BLUETOOTH™ communication, Internet, RF communication, or the like.

In some exemplary embodiments, a group plan for Room 101 including one or more fan configurations may be determined. In some exemplary embodiments, the group plan may include at least one operation that is to be performed by a fan-based device excluding Air Purifier 120, such as HVAC Unit 110 and HVAC Unit 130. In some exemplary embodiments, the operation may be implemented by selecting fan configurations for the fan-based device, and instructing the fan-based device to implement the fan configurations. In some exemplary embodiments, an interface with the controllable devices may be used to adjust configurations of the controllable devices, such as in order to increase the air circulation, to comply with constraints, or the like. In some exemplary embodiments, configurations of the controllable devices may include fan settings of ACs such as HVAC Unit 110, turning on or off fans of HVAC devices such as HVAC Units 110 and 130, or the like.

In some exemplary embodiments, an operation of a fan-based device may be determined periodically, in response to detected events, or the like. For example, measurements from one or more sensors may be utilized to detect events of interest, such as an inefficient circulation event, a constraint event, a priority event, or the like. For example, measurements may be obtained from sensors of Air Purifier 120, HVAC Units 110 and 130, Remote Control 115, non-depicted sensors, or the like.

In one scenario, a level of air circulation, indicating a coverage of air circulation within Room 101, may be measured, such as air quality sensors deployed in Room 101 (not depicted), an air quality sensor of Air Purifier 120, a profile of Room 101, or the like. In case the measured air circulation is insufficient, e.g., below a threshold, an operation may be determined to increase the air circulation. For example, fan configurations of HVAC Unit 130 may be selected to increase the air circulation, and HVAC Unit 130 may be instructed to set the fan configurations.

In one scenario, a presence or location of User 140 may be identified, such as by one or more user sensors in a location of Room 101 (not depicted), and used to determine a noise constraint for the user. In case a measured noise that is estimated to reach User 140 violated the noise constraint, a group plan may be determined to reduce the noise level, such as by selecting fan configurations of fan-based devices that comply with the noise constraint, while optimizing the air circulation as much as possible. For example, the noise constraints may define that a sound level of over 40 decibels should not reach the user, and an estimated sound level of current fans may be 50 decibels (e.g., estimated based on properties of the fans and their settings, or by sound sensors). According to this example, the group plan may be determined to set fan configurations of fan-based devices that are estimated to produce 45 decibels, 40 of which that are estimated to reach User 140 (e.g., through a wall), while producing a maximal air circulation.

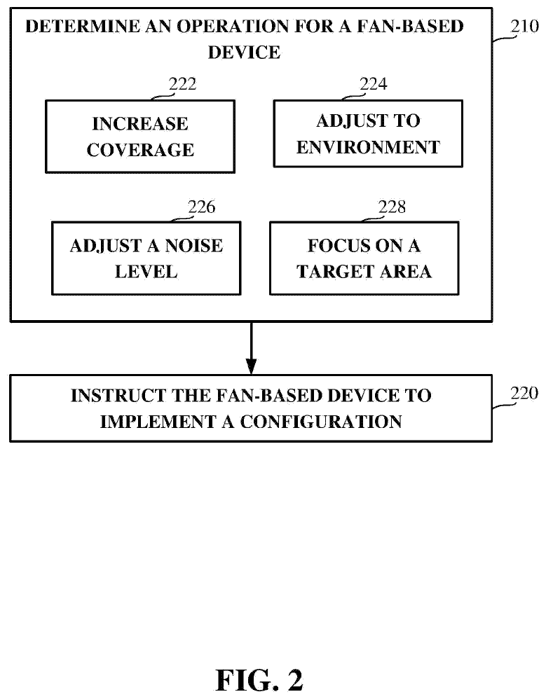

Referring now to FIG. 2, showing a flowchart diagram of a method, in accordance with some embodiments of the disclosed subject matter.

On Step 210, at least one operation may be determined for at least one fan-based device. In some exemplary embodiments, while an air purifier is activated, such as with a purifying operation, operations for one or more other fan-based device (e.g., air conditioners) may be determined, e.g., alone or in combination with operations of the air purifier. In some exemplary embodiments, the operations may be configured to achieve one or more desired effects together with the air purifier, such as complying with noise constraints, increasing an air circulation of the air purifier, or the like. In some exemplary embodiments, the operations may be determined based on one or more objectives, constraints, sensor readings, or the like, in order to enhance one or more aspects of the air quality. In some exemplary embodiments, an operation may be determined for one or more controllable devices in an environment, such as an air purifier, an air conditioner, or the like. In some cases, the environment may comprise devices with no fan, such as a shutter control, a window control, sensors for measuring data, communication devices, or the like.

In some exemplary embodiments, a group plan for one or more fan-based devices and for the air purifier may be determined, e.g., including a selection of fan configurations thereof. In some exemplary embodiments, fan configurations of operations may be selected. In some exemplary embodiments, each fan configuration may comprise configurations of a fan-based device such as an air purifier, an air conditioner, or the like. In some exemplary embodiments, the fan configurations may be configured to solve a problem that is associated to an event, detected by the event, or the like, to achieve one or more desired effects or objectives, or the like.

For example, the group plan may be determined to overcome one or more air quality issues detected by one or more events. In some exemplary embodiments, the group plan may be determined to control a group of devices as a combined group effort, such as in order to obtain one or more objectives, optimizations, or the like. In some exemplary embodiments, instead of merely utilizing the air purifier and components thereof in order to purifier and circulate the air, an entire group of one or more additional devices may be utilized in addition to the air purifier, and may be operated in view of their effects on each other, on areas of the environment, or the like.

In some exemplary embodiments, the fan configurations of the group plan may be selected based on a mapping of multiple fan configurations of fan-based devices, to respective effects of such configurations, effected areas of such configurations, sounds effects of such configurations, or the like. In some exemplary embodiments, the effects may comprise noise effects, circulation effects, locations of effected areas, or the like. In some exemplary embodiments, the mapping may be utilized to estimate a resulting air circulation, direction in space, strength, noise, or the like, that is produced by each fan configuration of each fan-based device, alone or in combination with other fan configurations. In some exemplary embodiments, based on the mapping of fan configurations to their effects in space, a combined effect of one or more fan settings and one or more fan-based devices on the air circulation may be determined. For example, fan configuration effects may include a level of produced circulation, a distribution of the circulation within the space, a coverage of the air circulation with respect to the environment, a noise produced in each area of the environment, a focus of the air circulation, or the like.

In some exemplary embodiments, the mapping may be determined based on historic fan configurations and corresponding effects on the air of the environment that were measured by one or more sensors, based on a room profile of the environment (e.g., a volume of the room), based on relative or absolute locations of deployed sensors and devices within the environment, based on properties or profiles of the fan-based devices, or the like. In some exemplary embodiments, the mapping may be determined based on properties of the environment, such as a characterization of the environment, a size thereof, a shape thereof (e.g., determined based on optical sensors or user input), a volume thereof, a number of separate rooms therein, a distribution path of air through the rooms, a number and type of fan-based devices in each room, a position of each fan-based device, properties of noise movements, or the like. In some exemplary embodiments, properties of the environment may be inputted by a user, or determined based on sensor readings, such as optical sensors, radar sensors, distances determined based on fine time measurements between sensors, or the like.

In some exemplary embodiments, the operation, or the group plan thereof, may be determined periodically, continuously, sequentially, upon a user activation of the air purifier, in response to detected events, or the like. For example, the desired operation may be determined in response to detecting an event that indicates suboptimal air conditions in the environment, a decreased air quality level in the environment, a change in outside environmental conditions, a detected violation of constraints, a location of a user, a change in a ratio between indoor and outdoor measurements, or the like. In some exemplary embodiments, an event may be detected based on one or more sensors, e.g., air sensors, user sensors, environment sensors, a combination thereof, or the like.

In some exemplary embodiments, determining the operations, or a group plan for implementing the operations, may include any of Steps 222-228, alone or in combination.

On Step 222, an air circulation coverage may be measured, and compared to a coverage threshold. In some exemplary embodiments, in case the measurements indicates that the air circulation is ineffective, the operation to be performed may be determined to include increasing a coverage of an air circulation. In some exemplary embodiments, a group plan including fan configurations of one or more fan-based devices, may be automatically determined to increase an effectiveness of the air circulation. In some exemplary embodiments, the operation may be implemented by selecting fan settings for air conditioners, fans, or the like, such as adjusting their fan configurations from low to high, turning on fans for the ACs, or the like.

In some exemplary embodiments, the air circulation coverage may be measured based on a comparison between sensors readings of multiple air quality sensors that measure the air of the environment at a same time. For example, an inconsistency between the results of air quality sensors may indicate that the air circulation is low. In some cases, a threshold may be set to differentiate between a desired circulation level and an undesired circulation level. In some exemplary embodiments, the air circulation coverage may be measured based on a difference between an expected speed of increasing an air quality of a room, and a measured change over time encountered in the air sensor of the purifier. In some cases, the expected time of increasing an air quality to a certain level may be determined based on an initial state of the air quality, an initial measurement of air pollution by the air sensor, or the like, in combination with the estimated air volume in the environment. In case that the air sensor of the purifier indicates that the air quality has improved drastically in less than the expected time, e.g., and the difference in time overpasses a threshold, this may indicate that the air sensor is sampling and filtering air in its immediate vicinity, without effecting the remaining air of the room, which may occur in the case of low air circulation. In such cases, the circulation level may be determined to be low, ineffective, or the like, and an operation of increasing the air circulation may be determined. In some exemplary embodiments, the expected speed of purifying the air may be determined based on an air volume, which may be determined based on a room profile, one or more characterizations of the space, a volume of the environment, a shape of the environment, or the like. In some exemplary embodiments, the expected speed of purifying the air may be determined based properties of the air purifier such as an engine type thereof, a type of filter used, or the like. In some exemplary embodiments, the air circulation level may be measured periodically, such as in order to determine whether additional operations are needed, whether the air circulation has reached a desired coverage, or the like.

In some exemplary embodiments, upon determining that the air circulation is to be increased, the fan configurations may be determined, adjusted, set, or the like, based on the mapping of fan configurations to their effects in space. In some exemplary embodiments, the mapping of fan configurations to their effects in space may be used to determine a setting of fan configurations that is estimated to increase the circulation speed and coverage, e.g., while complying with one or more constraints. In some exemplary embodiments, air circulation effects may be determined based on outdoor conditions, such as a state of windows or doors, a detected weather, or the like. For example, based on weather sensors that indicate a wind speed outside the window, and air sensors indicating that the air outside has low pollution properties, an effect of opening the window may be determined to increase an air circulation within the space.

In some exemplary embodiments, based on estimated effects of each fan configuration, window state, or the like, the group plan may be determined to include a selection of configurations for the controllable group of devices. In some exemplary embodiments, the configurations may be defined for a sub-group of the controllable group, for the entire controllable group, or the like, which may or may not be located in a same space, a same room, or the like. In some exemplary embodiments, the configurations may be selected by ordering or rating every selection of fan configurations, window configurations, or the like, according to an expected air circulation therefrom, and selecting a configuration with the highest rating. In some exemplary embodiments, the rating may rate one or more properties of the expected air circulation, such as in order to provide an average, weighted, or combined rating for each selection of fan and window settings. In some exemplary embodiments, fan configurations may be selected according to a combined rating of the expected air circulation therefrom, with one or more other criteria, constraints, objectives, or the like, such as by using a weighting function.

On Step 224, sensor readings from the outdoor environment may be measured, obtained, or the like, and the operation may be determined to include adjusting configurations of controllable devices to the outdoor environment. In some exemplary embodiments, a group plan including fan configurations of one or more fan-based devices, may be automatically determined to adjust fan-based devices to the outdoor environment, conditions, or the like. For example, in case that the sensor readings indicate a difference between a pollution level indoors and outdoors, or a change in a previous ratio between inside air pollution levels and outside air pollution levels, the operation may be determined to include selecting an air source of the air circulation to increase an air quality. In some exemplary embodiments, in case the measured air pollution of outside air is lower than a measured air pollution of inside air, the operation may comprise selecting a fresh air mode for an air conditioner. In the opposite case, an air-recycling mode may be selected. In some exemplary embodiments, a group plan with configurations of fan-based devices may be selected based on the determined operation.

In some exemplary embodiments, in addition to or instead of selecting an air source, a group plan may be determined or adjusted based on any other sensors, environmental parameters, data, or the like. In some cases, in response to detecting that outside air has a lower air pollution that inside air, a window may be determined to be opened, such that outside air can be drawn inside, and vice versa. In some exemplary embodiments, windows or doors may also be determined to open in case that the outside air is determined to increase an air circulation, in case that the outside air is determined to optimize one or more other objectives, or the like. In some exemplary embodiments, in case that large volumes of air are expected to enter the space, such as due to a high measured wind speed and open windows, the operation may include activating one or more non-active air purifiers, or increasing a cleaning speed of activated air purifiers, to thereby enable filtering of the large volume of air. In some exemplary embodiments, the operation may include any other adjustments to configurations of fan-based devices, based on any other environmental condition, sensor reading, or the like.

On Step 226, a noise constraint, or any other constraint, may be determined, and compliance therewith may be determined. In some exemplary embodiments, noise constraints may be determined based on a location of a user, such as to define a maximal noise level that is allowed to reach the user. In some exemplary embodiments, noise constraints may comprise a constraint on noise level that can be produced by air purifiers, air conditioners, or the like, alone or in combination, with respect to a living subject, a human subject, or the like. For example, the constraint may apply to sounds reaching a target area with a defined distance from a user. Alternatively, noise constraints may be defined globally, regardless of users, or with respect to any other user parameter. For example, noise constraints may define that a maximal noise that is allowed to be made in the space is 50 decibels [dB], or that a maximal noise that is allowed to be heard by a user is 50 dB, even if the actual decibels that are produced are higher, but only 50 dB reach the user. In some exemplary embodiments, noise constraints may be defined based on user inputs, inferred user preferences that may be inferred based on historic user interactions with fan settings, predefined settings, heuristics, rules, or the like.

In some exemplary embodiments, an operation may be determined to ensure compliance with the noise constraints. In some exemplary embodiments, in case noise constraints are violated by a combination of one or more fan-based devices such as the air purifier, HVAC units, or the like, an operation may be determined to decrease a sound produced by fans of the air purifier and the fan-based device. For example, the operation may include selecting a fan configuration for the fan-based device and/or the air purifier with a decreased fan speed that is estimated to reduce a sound emitted by the fan-based device and/or the air purifier.

In some exemplary embodiments, in order to determine compliance with noise constraints, one or more living subjects may be located. In some exemplary embodiments, living subjects may be located based on user sensors such as presence sensors, geolocation sensors, or the like, which may be utilized to estimate locations or presence of users in the surrounding space, rooms thereof, or the like. In some exemplary embodiments, violation of noise constraints may be determined based on periodical sensor measurements, such as noise sensors, based on violation events obtained from a user, based on a detected location of a user, based on a detected location change of the user, based on a change in an operation of a fan-based device, or the like.

In some exemplary embodiments, a tradeoff may exist between a noise level produced by fans of fan-based devices, and an air circulation level of the air. In some exemplary embodiments, fan-based devices such as air purifiers may, in some cases, have one or more fan setting that are noisy, constitute a disturbance, or the like. For example, a fan setting may indicate a speed of the fan, and may produce increased noise as the speed increases. In some exemplary embodiments, it may be desired to balance between noise level and the circulation level, e.g., according to one or more user preferences or weights, such as by selecting a highest circulation setting that complies with defined noise constraints, by selecting a lowest noise setting that complies with an air circulation threshold, or the like. In some exemplary embodiments, the group plan may be configured to determine fan configurations that will comply with constraints, while optimizing on one or more objectives such as an air circulation level, a noise level, or the like.

In some exemplary embodiments, the group plan of fan-based devices may be determined based on a mapping of settings of the fan-based devices to estimated noise effects thereof, air circulation effects thereof, or the like. In some exemplary embodiments, the mapping may map, for each fan configuration, an estimated noise level produced by the fan configuration. In some exemplary embodiments, a fan configuration may include setting a fan to a high, medium, or low speed setting, Air Conditioner (AC) temperature settings, turning an HVAC unit on or off, or the like. In some exemplary embodiments, the mapping of fan configurations to noise levels may be determined locally, obtained from a server, or the like. In some exemplary embodiments, the fan configurations may ordered or rated according to an expected noise effect thereof, e.g., according to the mapping. In some exemplary embodiments, based on the mapping, one or more properties of each fan configuration, e.g., the expected air circulation, noise, or the like, may be rated, such as in order to provide an average, weighted, or combined rating. In some cases, a combined score may be based on multiple factors, e.g., both the air circulation and the noise, according to one or more respective weights. In some cases, fan configurations that do not comply with noise constraints or circulation constraints may be filtered out, and the remaining fan configurations may be rated and selected according to one or more weights or properties thereof.

In some exemplary embodiments, based on detected locations or presence of living subjects, a target area including the user's location may be defined, and fan configurations affecting the target area may be identified in the mapping. In some exemplary embodiments, a combined effect of fan configurations on the target area may be determined based on the mapping, and compared to the noise constraints. For example, the mapping of fan configurations to effected areas may be determined based on a distance between the target area and each fan-based device, maps of the area, a room profile, or the like. The effect of each configuration of the target area may be summed up to determine an overall sound effect that will reach the target area. In some exemplary embodiments, compliance of sub-sets of fan configuration with noise constraints may be determined based on the mapping and on the target area. For example, in case a user is out of the house, and the noise constraints define that a user should not be exposed to a noise that overpasses a noise threshold, e.g., 80 decibels [dB] or any other threshold, fan-based devices may be set to their highest fan setting, since the user is absent, and the target area is void.

In some cases, fan configurations that comply with the noise constraints may be scored according to an objective function that may be configured to minimize the noise levels of the fan configuration, to maximize the air circulation, or the like, e.g., using one or more weights. In some cases, a configuration of a fan-based device may be selected for an operation based on one or more optimizers, constraint solvers, or the like. For example, a Constraint Satisfaction Problem (CSP) problem may be generated according to the noise constraints, the expected noise, or the like, and a CSP solver may solve the CSP problem by selecting an optimal configuration. Alternatively, any other method may be used to select a configuration that optimizes the air circulation, or any other objective, while reducing the noise, ensuring compliance with the noise constraints, or ensuring compliance with any other constraint.

On Step 228, locations or presence of living subjects may be detected, determined, indicated, or the like. In some exemplary embodiments, based on detected locations or presence of living subjects, a target area including such as an area around the user's location may be defined as a high priority area. Alternatively, high priority areas may be defined to include any type of location. In some exemplary embodiments, the operation may include increasing an air quality within the high priority area, prior to increasing the air quality in other areas of the environment, focusing an air circulation effort of the air purifier and air conditioner to the target area, or the like.

In some exemplary embodiments, the operation may be determined periodically upon determining a user's location within the environment, based on direct user instructions, based on one or more sensor-based events, such as a priority event indicating that some areas are determined to have higher priority for being purified than others, a user setting to clean priority areas, or the like. For example, a user may move to a location with poor air quality, and the operation may include cleaning the air in the new location with high priority, such as before cleaning other air areas in the space.

In some exemplary embodiments, determining the operation may include selecting fan configuration for fan-based devices affecting the target area, e.g., in the mapping. In some exemplary embodiments, the mapping may map one or more fan configurations to one or more areas in the space that each fan configuration is expected to affect, an expected effect in each area, or the like. In some exemplary embodiments, fan-based devices may focus an air circulation effort to the target area by increasing an air circulation in the target area. For example, air may be drawn from and directed to target areas, so that the air in near proximity to the users may be purified swiftly, before other locations. In some exemplary embodiments, fan configurations that, according to the mapping, are estimated to increase an air quality of the target area as fast as possible (e.g., while complying with one or more constraints such as noise constraints) may be selected, to thereby increase an air quality of air breathed by the user or her pet.

On Step 220, at least one fan-based device may be instructed to implement selected configurations, e.g., as selected on Step 210 or any of sub-steps 222, 224, 226, and 228, alone or in combination.

In some exemplary embodiments, the instructions may be provided to one or more devices of the controllable group from a managing layer on a cloud, a remote server, a local computing agent in the environment, a local computing agent adjacent to the environment, or the like. In some exemplary embodiments, the instructions may control the controllable group using one or more communications, control messages, control signals, or the like, in a manner that matches technologies and protocols of receiving devices.

In some exemplary embodiments, in addition to instructing fan-based devices, one or more windows and doors devices may be instructed. For example, in case the determined configurations indicate that a window should be opened or closed, an instruction may be provided to an automatic window opener. In case the window is not automatically controllable, the user may be instructed to open or close one or more windows or doors, such as via a notification or alert presented in a user interface of the purifier, an associated website, an associated application, a message, or the like.

In some exemplary embodiments, the instructions may be determined and adjusted, modified, or the like, dynamically, in real time, iteratively, or the like, such as based on newly determined operations on Step 210. In some exemplary embodiments, implementing the group plan may have one or more effects, such as increasing the air circulation, increasing the air quality in one or more areas, or the like, without violating constraints.

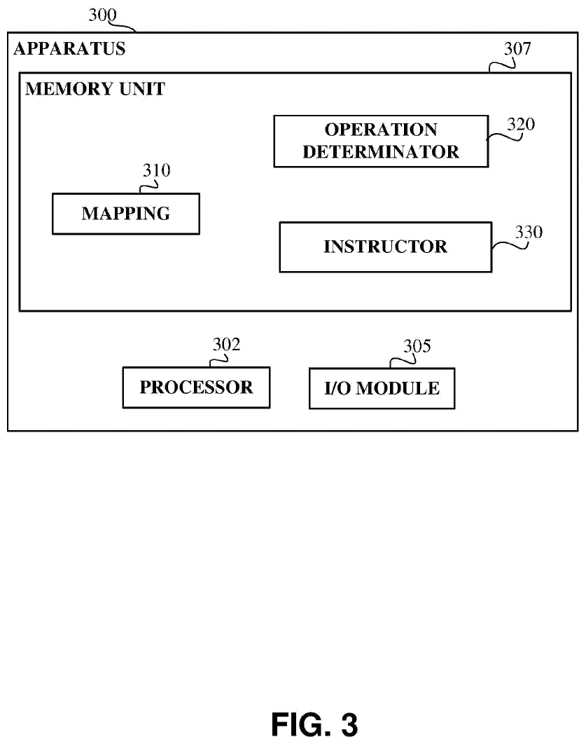

Referring now to FIG. 3 showing a block diagram of an apparatus, in accordance with some exemplary embodiments of the disclosed subject matter.

In some exemplary embodiments, an Apparatus 300 may comprise a Processor 302. Processor 302 may be a Central Processing Unit (CPU), a microprocessor, an electronic circuit, an Integrated Circuit (IC) or the like. Processor 302 may be utilized to perform computations required by Apparatus 300 or any of its subcomponents. Processor 302 may be configured to execute computer-programs useful in performing the method of FIG. 2, or the like.

In some exemplary embodiments of the disclosed subject matter, an Input/Output (I/O) Module 305 may be utilized to provide an output to and receive input from a user device, sensors, or the like. I/O Module 305 may be used to transmit and receive information to and from any apparatus in communication therewith. I/O Module 305 may be used to transmit instructions to one or more sensors, fan-based devices, or any other controllable device.

In some exemplary embodiments, Apparatus 300 may comprise a Memory Unit 307. Memory Unit 307 may be a short-term storage device or long-term storage device. Memory Unit 307 may be a persistent storage or volatile storage. Memory Unit 307 may be a disk drive, a Flash disk, a Random Access Memory (RAM), a memory chip, or the like. In some exemplary embodiments, Memory Unit 307 may retain program code operative to cause Processor 302 to perform acts associated with any of the subcomponents of Apparatus 300. In some exemplary embodiments, Memory Unit 307 may retain program code operative to cause Processor 302 to perform acts associated with any of the steps in FIG. 2, or the like.

In some exemplary embodiments, Memory Unit 307 may comprise a Mapping 310. Mapping 310 may comprise mappings of fan configurations of fan-based devices to respective effects, effected areas, or the like, that are affected by setting the fan configurations.

The components detailed below may be implemented as one or more sets of interrelated computer instructions, executed for example by Processor 302 or by another processor. The components may be arranged as one or more executable files, dynamic libraries, static libraries, methods, functions, services, or the like, programmed in any programming language and under any computing environment.

In some exemplary embodiments, Memory Unit 307 may comprise an Operation Determinator 320. In some exemplary embodiments, Operation Determinator 320 may be configured to determine one or more operations that are estimated to achieve one or more desired effects according to Mapping 310, such as to ensure compliance with constraints, to increase an air quality level, or the like. The operations may include operations for fan-based devices, or for any other device. In some exemplary embodiments, Operation Determinator 320 may determine an operation for a device in response to an event, such as an event indicating a violation of a constraint, based on monitored sensor readings, or the like. In some exemplary embodiments, based on determined operations, Operation Determinator 320 may determine a group plan including fan configurations of one or more fan-based devices, that are estimated to enhance the air quality, the air circulation coverage, or the like. In some cases, the group plan may include a selection of configurations of devices that have no fans.

In some exemplary embodiments, Memory Unit 307 may comprise an Instructor 330. In some exemplary embodiments, Instructor 330 may be configured to instruct one or more fan-based devices, or any other controllable devices (e.g., a window opener), to implement the group plan determined by Operation Determinator 320. In some cases, Instructor 330 may be configured to instruct a user to manually perform an action, such as to open a window.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method operated in an environment where an air purifier and a fan-based device are deployed, wherein the air purifier and the fan-based device are physically separated, wherein the air purifier is being operated to purify an air within the environment, the method comprising:
determining an operation to be performed by the fan-based device, wherein the operation is configured to achieve a desired effect together with a purifying operation of the air purifier, wherein said determining the operation comprises selecting a configuration for the fan-based device that is configured to cause the fan-based device to perform the operation; and
instructing the fan-based device to implement the configuration, whereby causing the fan-based device to perform the operation;
whereby the air purifier and the fan-based device achieve the desired effect together.

2. The method of claim 1, wherein said determining the operation is performed in response to a determination that a noise constraint within the environment is violated, wherein the desired effect is a decrease in a sound produced by fans of the air purifier and the fan-based device, wherein the configuration is configured to reduce a sound emitted by the fan-based device.

3. The method of claim 2 further comprises instructing the air purifier to reduce a fan speed, whereby reducing sound emitted by the air purifier.

4. The method of claim 2, wherein the noise constraint comprises a constraint on a noise level that can be produced at a defined distance from a living subject.

5. The method of claim 2, wherein said determining comprises detecting a presence of a living subject in the environment, and determining the noise constraint based on the presence of the living subject in the environment.

6. The method of claim 1 further comprises:
detecting a location of a living subject in the environment; and
determining a target area based on the location of the living subject;
wherein the desired result is focusing air circulation at the target area, whereby directing air flow of purified air to the living subject, wherein the purified air is purified by the air purifier.

7. The method of claim 6 further comprises determining an air quality level at the target area, wherein the operation is subject to the air quality level being below a threshold, whereby improving air quality at the target area.

8. The method of claim 1, wherein the configuration for the fan-based device is a mode of air re-circulation of the fan-based device, whereby affecting the operation of the air purifier by the fan-based device.

9. The method of claim 8, wherein the mode of air re-circulation of the fan-based device is determined based on an air pollution level at the environment and an air pollution level at a location external to the environment.

10. The method of claim 1, wherein the desired effect is an increase in a coverage of an air circulation in the environment, wherein the operation is selected from the group consisting of:
an increase of a fan-speed of the fan-based device; and
a change in a direction of an air output from the fan-based device.

11. The method of claim 10, further comprises determining that a current coverage of air circulation in the environment is insufficient, wherein said determining that the current coverage is insufficient comprises:
determining a difference between an expected speed of air purification by the air purifier, and a measured speed of air purification, wherein the expected speed of air purification is determined based on a volume of air in the environment, wherein the measured speed of air purification is measured using a sensor.

12. The method of claim 11, wherein in response to a determination that the measured speed of air purification is higher than the expected speed of air purification, determining that the current coverage is insufficient.

13. The method of claim 11, wherein the air purifier comprises the sensor, wherein the measured speed of air purification is measured using at least two sensor readings by the sensor.

14. The method of claim 13, wherein the measured speed of air purification is measured without using any air quality sensor external to the air purifier.

15. The method of claim 10, wherein the increase in the coverage of the air circulation is achieved by instructing to open a window in response to determining that a measured air pollution of outside air is lower than a measured air pollution of inside air.

16. An apparatus comprising a processor and coupled memory, said processor being adapted to perform, in an environment where an air purifier and a fan-based device are deployed, the steps of:
determining an operation to be performed by the fan-based device, wherein the air purifier and the fan-based device are physically separated, wherein the air purifier is being operated to purify an air within the environment, wherein the operation is configured to achieve a desired effect together with a purifying operation of the air purifier, wherein said determining the operation comprises selecting a configuration for the fan-based device that is configured to cause the fan-based device to perform the operation; and
instructing the fan-based device to implement the configuration, whereby causing the fan-based device to perform the operation;
whereby the air purifier and the fan-based device achieve the desired effect together.

17. The apparatus of claim 16, wherein the desired effect is an increase in a coverage of an air circulation in the environment, wherein the operation is selected from the group consisting of:
an increase of a fan-speed of the fan-based device; and
a change in a direction of an air output from the fan-based device.

18. The apparatus of claim 16, wherein said determining the operation is performed in response to a determination that a noise constraint within the environment is violated, wherein the desired effect is a decrease in a sound produced by fans of the air purifier and the fan-based device, wherein the configuration is configured to reduce a sound emitted by the fan-based device.

19. The apparatus of claim 16, wherein the processor is further adapted to:
detect a location of a living subject in the environment; and
determine a target area based on the location of the living subject;
wherein the desired result is focusing air circulation at the target area, whereby directing air flow of purified air to the living subject, wherein the purified air is purified by the air purifier.

20. A computer program product comprising a non-transitory computer readable medium retaining program instructions, which program instructions when read by a processor, cause the processor to perform a method in an environment where an air purifier and a fan-based device are deployed, wherein the air purifier and the fan-based device are physically separated, wherein the air purifier is being operated to purify an air within the environment, the method comprising:
determining an operation to be performed by the fan-based device, wherein the operation is configured to achieve a desired effect together with a purifying operation of the air purifier, wherein said determining the operation comprises selecting a configuration for the fan-based device that is configured to cause the fan-based device to perform the operation; and
instructing the fan-based device to implement the configuration, whereby causing the fan-based device to perform the operation;
whereby the air purifier and the fan-based device achieve the desired effect together.
